(19) United States
(12) Patent Application Publication
(10) Pub. No.: US 2009/0211964 A1
(43) Pub. Date: Aug. 27, 2009

(54) Corrugated-Ribbed Thread Plates for Oil/Fuel Spin-on Filters

(75) Inventors: Rajan AHUJA, Fayetteville, NC (US); L. Steven CLINE, Fayetteville, NC (US)

Correspondence Address: CROWELL & MORING LLP;INTELLECTUAL PROPERTY GROUP, P.O. BOX 14300, WASHINGTON, DC, 20044-4300, US

(73) Assignee: PUROLATOR FILTERS NA LLC, Fayetteville, NC (US)

(21) Appl. No.: 12/038,481

(22) Filed: Feb. 27, 2008

(51) Int. Cl. B01D 27/06

(52) U.S. Cl. 210/457

(57) ABSTRACT

An improved, reduced waste fluid filter has a concave housing having a first end, a second end, a fluid inlet port and a fluid outlet port. A cover plate assembly is sealably attached to a second end of the housing providing a closed area with which the inlet and outlet ports communicate. The cover plate assembly contains a retainer and a thread mounting plate. The improved thread mounting plate has thin steel with corrugations or ribs for stiffening the plate and is assembled with the retainer to form the cover plate assembly. An elongated cylindrical disposable fluid filter element is supported within the closed area of the housing and cover plate assembly. The filter element has a perforated center tube, a first end of which communicates with the fluid outlet port, the other end of the center tube being closed. The center tube has a filter media there around so that fluid flow into the closed area through the inlet port flows through the filter media and into the center tube to pass out through the outlet port.

### BACKGROUND

Fluid filters are used on internal combustion engines in various types of vehicles, such as automobile, bus, truck, and boat engines. Typical fluid filters have a concave housing with a first end, a second end, a fluid inlet port, and a fluid outlet port. A cover plate assembly is sealably attached to a second end of the housing providing a closed area with which the inlet and outlet ports communicate. The cover plate assembly includes a retainer and a thread mounting plate.

Many types of thread mounting plates (also referred to as a “cover plate” or “backing plate”) are known in the prior art. Thread mounting plates are currently designed and built in plain, convex, or concave shapes, which are designed to match the mounting designs, for example, dome-up and dome-down, on engine mountings to provide for a thread start point based upon the length and orientation of the threaded mounting stud. The thread mounting plate is assembled with another component known as a retainer in order to construct a cover base plate assembly for a spin-on oil or fuel filter.

The thread mounting plates are designed in various thicknesses in order to comply with mechanical strength standards as measured by hydrostatic burst tests, impulse tests, and vibration tests. More recently, thread plates have been designed to increasingly thick material specifications in order to comply with the increasingly stringent mechanical strength parameters for hydrostatic burst and other robustness measurements.

### SUMMARY OF THE INVENTION

The present invention provides fluid filters for extracting solid particles from the lubrication systems of internal combustion engines. The fluid filter includes a rigid housing designed essentially to be permanently or semi-permanently affixed to an internal combustion engine. The housing has an end that is attached to an engine, the attachment end being in the form of an integral mounting end plate that has a fluid inlet port or ports and a fluid outlet port. In a typical arrangement, a fluid outlet port may be centrally positioned in the housing end plate, and the fluid inlet is in the form of a plurality of openings spaced around and separate from the fluid outlet port. The fluid outlet port may also function as a means of mounting the housing to an engine.

A cover plate assembly is sealably attached to a second end of the housing. The cover plate assembly includes a thread mounting plate and a retainer. The present invention is directed to an improved thread mounting plate made of thinner steel with corrugations or ribs for stiffening the plate that is assembled with the retainer to form the cover plate assembly.

The thread mounting plate of the present invention has improved strength compared to traditional designs. In one embodiment, an improved thread mounting plate is provided with corrugations or ribs for stiffening the plate at the time of press operation or draw. The plate exhibits the desired strength requirements while being made of relatively thin steel instead of a higher thickness steel. The thread mounting plate of the present invention is typically 10 to 15 percent thinner than that presently used in cover plate assemblies. The thread mounting plate made of thinner steel with corrugations or ribs makes it easier to form the shape for the seal gasket groove and seam design, more specifically for a single-piece design. The corrugations or ribs are preferably achieved through a cold-forming-press operation that stiffens the base plate; giving rise to an increase in mechanical strength as tested by a hydrostatic burst test. The thread mounting plate may be assembled with the retainer, either by clinching or welding the retainer to the thread mounting plate to form the cover plate assembly.

When the cover plate assembly is attached to the housing, a closed area is formed with which the outlet and inlet ports communicate. Mounted within the enclosed area formed by the housing and the cover plate assembly is a filter element. The filter element preferably has a perforated center tube, a first end of which is in detachable communication with the housing end plate fluid outlet port. The second end of the center tube is typically closed.

Located around the center tube is a filter media formed of material that permits the flow of fluid therethrough but that intercepts solid particles. In some cases, the filter media may also absorb and retain water flowing in the lubricant; however, the normal function of the filter media is to intercept solid particles. The filter media is formed around the center tube in such a way that the fluid can normally flow from the housing inlet port or ports to the housing outlet port only by passing through the filter media. If the filter media becomes clogged with solid particles so that the fluid pressure necessary to force lubricant flow through the filter media builds to a preselected high level, then a bypass valve may be forced open to permit fluid flow from the housing inlet port or ports, through the bypass valve into the center tube and out the outlet port without passing through the filter media. This typically occurs only in an emergency situation, where the filter media has become clogged with solid particles; in normal operation, all lubricant fluid flow takes place through the filter media.

The center tube is typically tubular, that is, with an external cylindrical surface that receives the filter media thereon, the filter media being, for example, pleated filter paper.

As stated above, in one embodiment of the invention an improved thread mounting plate is provided with corrugations or ribs for stiffening the plate at the time of press operation or draw. The corrugations or ribs can be formed on the circumferential groove outside of the area where the inlet ports are located.

In another embodiment of the invention, an improved thread mounting plate is provided wherein the corrugations or ribs can be formed between the inlet ports on the thread mounting plate.

In still another embodiment of the invention, an improved thread mounting plate is provided wherein the corrugations or ribs can be formed between the inlet ports and in addition, on the circumferential groove outside of the area where the inlet ports are located.

An important advantage of the improved thread mounting plates is that the plates exhibit the desired strength requirements while being made of relatively thinner steel instead of a higher thickness steel. The thinner steel of the thread mounting plates makes it easier to form the shape for the seal gasket groove and seam design and is easy and cost-effective to build and install.

Other aspects, features, and techniques of the invention will be apparent to one skilled in the art in view of the following detailed description of the invention.

### BRIEF DESCRIPTION OF THE DRAWINGS

FIG. 1 is a partial cross-sectional perspective view of the fluid filter of the present invention.

FIG. 2a is a top view of the thread mounting plate as viewed in the direction of the engine of the corrugated-ribbed thread mounting plate, wherein the corrugations or ribs are formed on the circumferential groove outside of the area where the inlet ports are located and raised toward the engine;

FIG. 2b is a side view of the thread mounting plate, wherein the corrugations or ribs are formed on the circumferential groove outside of the area where the inlet ports are located and raised toward the engine;

FIG. 2c is an end view of the thread mounting plate as viewed in the direction of the mounting base of the corrugated-ribbed thread mounting plate, wherein the corrugations or ribs are formed on the circumferential groove outside of the area where the inlet ports are located and raised toward the engine;

FIG. 2d is a pictorial view of the top of the thread mounting plate as viewed in the direction of the engine of the corrugated-ribbed thread mounting plate, wherein the corrugations or ribs are formed on the circumferential groove outside of the area where the inlet ports are located and raised toward the engine;

FIG. 2e is a cross-sectional view of the thread mounting plate, wherein the corrugations or ribs are formed on the circumferential groove outside of the area where the inlet ports are located and raised toward the engine;

FIG. 2f is a cross-sectional view of the corrugations or ribs of the thread mounting plate, wherein the corrugations or ribs are formed on the circumferential groove outside of the area where the inlet ports are located and raised toward the engine;

FIG. 3a is a top view of the thread mounting plate as viewed in the direction of the engine of the corrugated-ribbed thread mounting plate, wherein the corrugated ribs of the present invention are formed in between the inlet ports and raised toward the engine;

FIG. 3b is an end view of the thread mounting plate as viewed in the direction of the mounting base of the corrugated-ribbed thread mounting plate, wherein the corrugated ribs of the present invention are formed in between the inlet ports and raised toward the engine;

FIG. 4a is a top view of the thread mounting plate as viewed in the direction of the engine of the corrugated-ribbed thread mounting plate, wherein the corrugations or ribs are formed between the inlet ports and in addition, on the circumferential groove outside of the area where the inlet ports are located and raised toward the engine;

FIG. 4b is an end view of the thread mounting plate as viewed in the direction of the mounting base of the corrugated-ribbed thread mounting plate, wherein the corrugations or ribs are formed between the inlet ports and in addition, on the circumferential groove outside of the area where the inlet ports are located and raised toward the engine.

### DETAILED DESCRIPTION

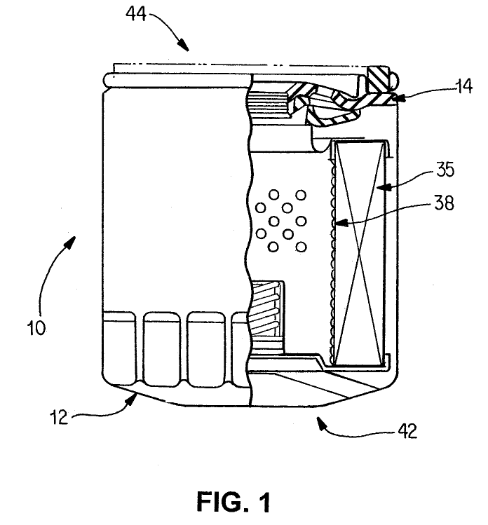

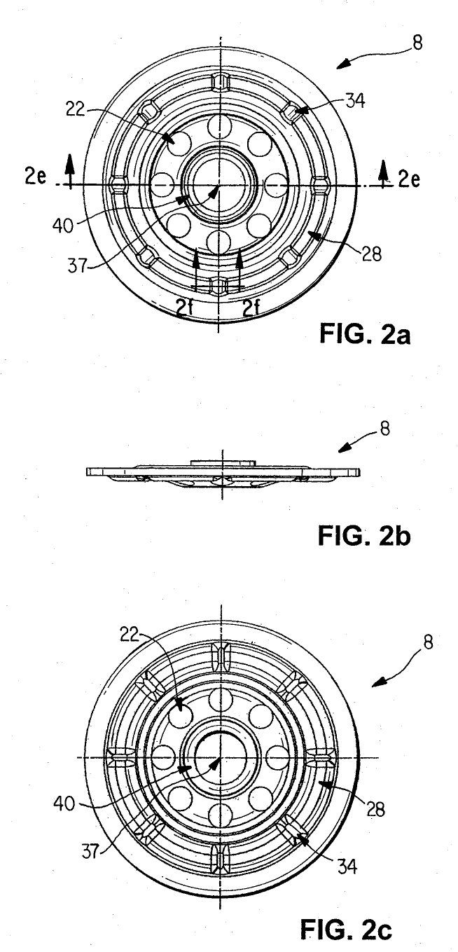

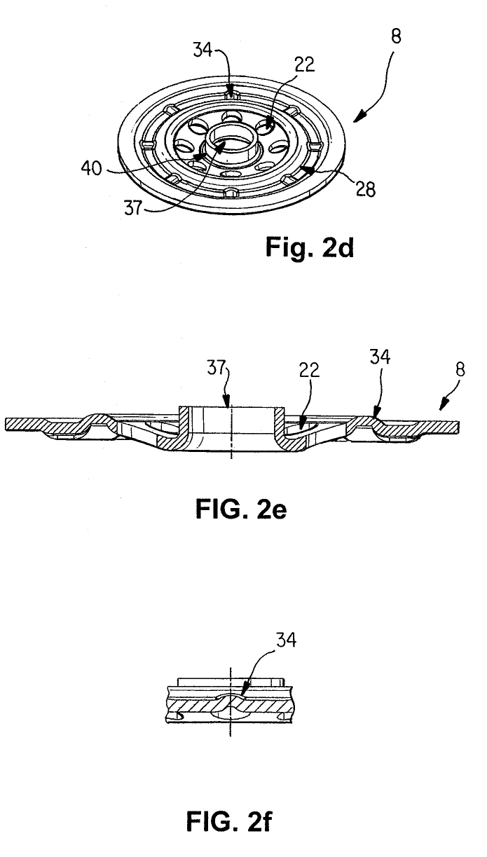

FIG. 1 illustrates a fluid filter 10 of the present invention. The fluid filter 10 includes a concave housing 12 having a first end 42, a second end 44, a fluid inlet port 22 and a fluid outlet port 37 (see FIGS. 2a-2f). A cover plate assembly 14 is sealably attached to a second end 44 of the housing 12 providing a closed area with which the inlet ports 22 and outlet ports 37 communicate. The cover plate assembly 14 includes a retainer (not shown) and a thread mounting plate 8 (see FIGS. 2a-2f), the thread mounting plate 8 having thin steel with corrugations or ribs for stiffening the plate An elongated cylindrical filter element 35 is supported within the closed area of the housing 12 and cover plate assembly 14. The filter element 35 surrounds a perforated center tube 38, where a first end of the center tube communicates with the fluid outlet port 37 and the other end of the center tube is closed. The center tube 38 has a filter media (not shown) there around so that fluid flow into the closed area through the inlet port 22 flows through the filter media (not shown) and into the center tube 38 to pass out through the outlet port 37.

In FIGS. 2a through 2f, an embodiment of a thread mounting plate 8 is illustrated, which has corrugated ribs 34 formed on the circumferential groove 28 outside of the area where the inlet ports 22 are located and raised toward the engine. The housing 12 has a second end 44 that is in the form of a cover plate assembly 14, including a retainer (not shown) and a thread mounting plate 8 having a circumferential grove 28 that receives a gasket (not shown).

Formed in the thread mounting plate 8 are a plurality of fluid inlet ports 22. These inlet ports 22 communicate with the interior chamber (not shown) formed by the housing 12 and the cover plate assembly 14. Centrally formed within thread mounting plate portion 8 is a central outlet port 37 having internal threads 40 therein. Inlet ports 22 are spaced circumferentially around outlet port 37. The fluid filter 10 is attached to an internal combustion engine by rotating housing to thread outlet port 37 onto an externally threaded tubular support (not shown) so that gasket (not shown) sealably engages a planar sealing surface (not shown). Gasket (not shown) sits on top of the corrugated ribs 34. The sealing surface (not shown) has oil flow channels in communication with inlet ports 22. Thus, in a manner that is typical of the way that fluid filters are commonly attached to an internal combustion engine, the housing 12 is threaded onto an externally threaded tubular member to simultaneously make attachment to an engine lubrication system that includes flow channels that provide communication with fluid filter inlet port 22 and outlet port 37. Eight inlet ports 22 and corrugated ribs 34 are illustrated; however, any suitable number of inlet ports 22 and corrugated ribs 34 may be used.

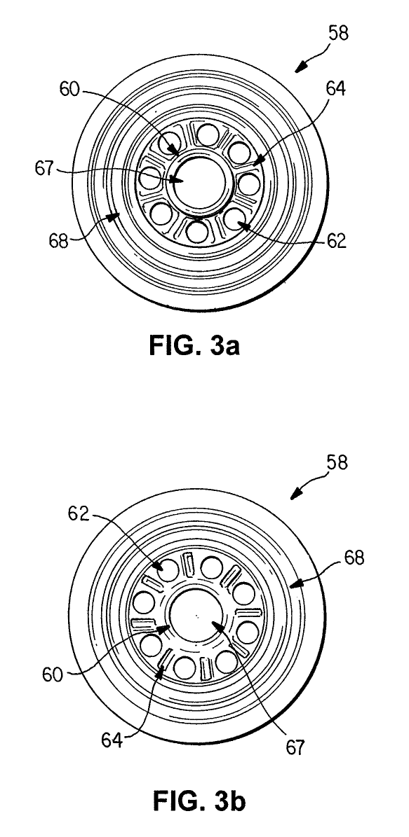

In FIGS. 3a and 3b, an alternative embodiment of a thread mounting plate 58 is illustrated, which has corrugated ribs 64 formed in between the inlet ports 62 and raised toward the engine. The housing 12 has a second end 44 that is in the form of a cover plate assembly 14, including a retainer (not shown) and a thread mounting plate 58 having a circumferential grove 68 that receives a gasket (not shown). As with the thread mounting plate embodiment illustrated in FIGS. 2a-2f, thread mounting plate 58 of the present embodiment interacts, connects, and operates with the remainder of the filter elements and assembly in the same manner as described above with respect to FIGS. 2a-2f.

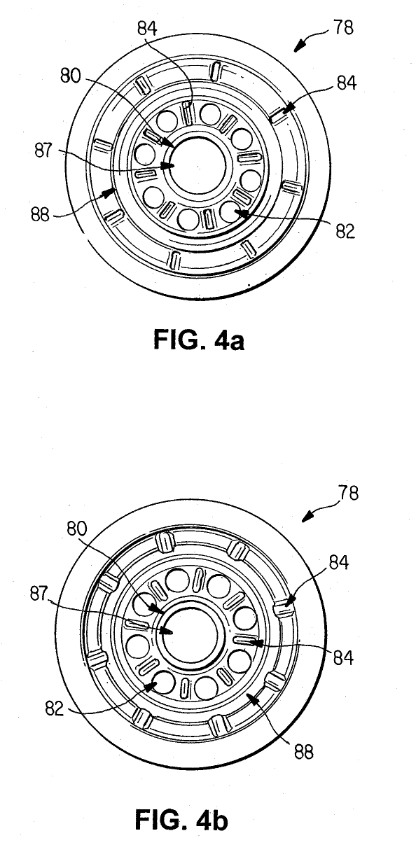

In FIGS. 4a and 4b, another alternative embodiment of a thread mounting plate 78 is illustrated, which has corrugated ribs 84 formed in between the inlet ports 82 and on the circumferential groove 88 outside of the area where the inlet ports 82 are located and raised toward the engine. The housing 12 has a second end 44 that is in the form of a cover plate assembly 14, including a retainer (not shown) and a thread mounting plate 78 having a circumferential grove 88 that receives a gasket (not shown). As with the thread mounting plate embodiment illustrated in FIGS. 2a-2f, thread mounting plate 78 of the present embodiment interacts, connects, and operates with the remainder of the filter elements and assembly in the same manner as described above with respect to FIGS. 2a-2f.

The design of the corrugated ribs can be modified in any manner that is possible in light of the above teachings. For example, the corrugated ribs can be radial to the center or concentric to the center or radial to the gasket or concentric to the gasket. In addition, the teachings of the present invention can be applied to any structure or materials that may be understood as within the scope of the appended claims.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. A fluid filter assembly, comprising:
a housing having a first end and a second end;
a cover plate assembly sealably attached to the second end of the housing providing a closed area, wherein said cover plate assembly further comprises a retainer and a thread mounting plate, said thread mounting plate being formed with corrugated ribs and having at least one fluid inlet port and a fluid outlet port; and
an elongated cylindrical fluid filter element within the closed area of the housing and the cover plate assembly,
wherein the filter element has a perforated center tube, a first end of which communicates with the fluid outlet port, the other end of the center tube being closed, and
said center tube having a filter media therearound so that fluid flows into the closed area through said at least one inlet port, then flows through the filter media and into the center tube to pass out through the outlet port.

2. The fluid filter assembly of claim 1, wherein the corrugated ribs are formed on a circumferential groove outside of an area where said at least one inlet port is located.

3. The fluid filter assembly of claim 2, wherein the corrugated ribs are concentric to the circumferential groove.

4. The filter assembly of claim 2, wherein the corrugated ribs are radial to the circumferential groove.

5. The fluid filter assembly of claim 1, having at least two inlet ports, wherein the corrugated ribs are formed in between the inlet ports.

6. The fluid filter assembly of claim 5, wherein the corrugated ribs are concentric to the inlet ports.

7. The fluid filter assembly of claim 5, wherein the corrugated ribs are radial to the inlet ports.

8. The fluid filter assembly of claim 1, having at least two inlet ports, wherein the corrugated ribs are formed in between the inlet ports and on a circumferential groove outside of an area where the inlet ports are located.

9. The fluid filter assembly of claim 8, wherein the corrugated ribs formed in between the inlet ports are concentric to the inlet ports and the corrugated ribs formed on the circumferential groove outside of the area, and wherein the inlet ports are located concentric to the circumferential groove.

10. The fluid filter assembly of claim 8, wherein the corrugated ribs formed in between the inlet ports are radial to the inlet ports and the corrugated ribs formed on the circumferential groove outside of the area, and wherein the inlet ports are located radial to the circumferential groove.

11. A cover plate assembly for a fluid filter, comprising:
a retainer; and
a thread mounting plate, said thread mounting plate containing at least one inlet port, an outlet port, and being formed with corrugated ribs.

12. The cover plate assembly of claim 11, wherein the corrugated ribs are formed on a circumferential groove outside of an area where the inlet ports are located.

13. The cover plate assembly of claim 12, wherein the corrugated ribs are concentric to the circumferential groove.

14. The cover plate assembly of claim 12, wherein the corrugated ribs are radial to the circumferential groove.

15. The cover plate assembly of claim 11, having at least two inlet ports, wherein the corrugated ribs are formed in between the inlet ports.

16. The cover plate assembly of claim 15, wherein the corrugated ribs are concentric to the inlet ports.

17. The cover plate assembly of claim 15, wherein the corrugated ribs are radial to the inlet ports.

18. The cover plate assembly of claim 11, having at least two inlet ports, wherein the corrugated ribs are formed in between the inlet ports and on a circumferential groove outside of an area where the inlet ports are located.

19. The cover plate assembly of claim 18, wherein the corrugated ribs formed in between the inlet ports are concentric to the inlet ports and the corrugated ribs formed on the circumferential groove outside of the area, and wherein the inlet ports are located concentric to the circumferential groove.

20. The cover plate assembly of claim 18, wherein the corrugated ribs formed in between the inlet ports are radial to the inlet ports and the corrugated ribs formed on the circumferential groove outside of the area, and wherein the inlet ports are located radial to the circumferential groove.

21. A method for assembling a cover plate assembly for a fluid filter comprising:
forming corrugated ribs on a thread mounting plate; and
attaching the thread mounting plate to a retainer.

22. The method of claim 21, wherein the thread mounting plate has a plurality of inlet ports and an outlet port.

23. The method for assembling the cover plate assembly of claim 22, wherein the forming of corrugated ribs includes the corrugated ribs being formed on a circumferential groove outside of an area where the inlet ports are located.

24. The method for assembling the cover plate assembly of claim 22, wherein the forming of corrugated ribs includes the corrugated ribs being formed in between the inlet ports.

25. The method for assembling the cover plate assembly of claim 22, wherein the forming of corrugated ribs includes the corrugated ribs being formed in between the inlet ports and on the circumferential groove outside of an area where the inlet ports are located.

26. The method for assembling a cover plate assembly of claim 22, wherein the attaching of the thread mounting plate to a retainer includes either clinching or welding the retainer to the thread mounting plate.
